(19) United States
(12) Patent Application Publication
(10) Pub. No.: US 2026/0344716 A1
(43) Pub. Date: Nov. 5, 2026

(54) Extruded Snack Product

(71) Applicant: GEA FOOD SOLUTIONS BAKEL B.V., Bakel (NL)

(72) Inventor: Johannes Matheus Martinus Petrus Van Den Hanenberg, Nuland (NL)

(21) Appl. No.: 19/488,386

(22) PCT Filed: Jun. 18, 2024
(86) PCT No.: PCT/EP2024/066960

§ 371 Date: Nov. 26, 2025

(30) Foreign Application Priority Data
Jun. 19, 2023 (EP) 23179945.3

(51) Int. Cl. A23L 13/60; A23J 3/22; A23J 3/26; A23P 30/25

(52) U.S. Cl. CPC A23L 13/62; A23J 3/227; A23J 3/26; A23P 30/25

(57) ABSTRACT

An extruded protein snack product for human consumption that includes: A. a first meat- and/or meat-substitute-mass; and/or B. a second meat-and/or meat-substitute-mass, the first meat- and/or meat-substitute-mass and the second meat- and/or meat-substitute-mass differ in at least one property and are at least essentially not mixed; and/or C. a Cheese or a cheese component; and/or D. a filling that is surrounded by at least one of A.-C.; and/or E. a topping that is provided on a surface of A.-C.

### CROSS REFERENCE TO RELATED APPLICATIONS

This application is a national stage entry of International Application No. PCT/EP2024/066960, filed Jun. 18, 2024, which claims priority to European Patent Application No. EP 23179945.3, filed Jun. 19, 2023. The foregoing applications are incorporated by reference herein in their entireties.

### FIELD

The present invention relates to an extruded protein snack product for human consumption. The present invention further relates to an extruder, a line and a method to produce the snack product.

### BACKGROUND

There is a need to provide industrially produced snack products for human consumption which are made from meat, cheese and/or a meat substitute mass and do not comprise dough.

### SUMMARY

It is therefore the problem of the present invention to provide an extruded protein snack product for human consumption, and an extruder, a line and a method to produce such a product.

The problem is solved with an extruded protein snack product for human consumption comprising:
A. A first meat-and/or meat-substitute-mass and/or
B. A second meat-and/or meat-substitute-mass, wherein the first-and the second mass differ in at least one property and are at least essentially not mixed and/or
C. A Cheese or a cheese component and/or
D. A filling that is surrounded by at least one of A.-C. and/or
E. A topping that is provided on the surface of A.-C.

The disclosure regarding this subject matter also applies to the other subject matters and vice versa. Subject matters disclosed in connection with this subject matter can be combined with other subject matters and vice versa.

The present invention relates to an extruded protein snack product which may comprise a first meat mass and preferably additionally second meat mass. The meat mass can be pork-, beef-, chicken, lamb- or any other meat. The first- and/or second meat mass is preferably ground meat. The first-and/or second meat mass can also comprise or be made of insects, preferably ground insects and/or fish, preferably ground fish and/or cultured meat.

A snack product can be a product for human-or animal consumption.

Alternatively or additionally, the inventive snack product may comprise a meat-substitute mass. This meat-substitute mass is preferably a food product made from vegetarian or vegan ingredients, preferably eaten as a replacement for meat. Meat substitutes typically approximate qualities of specific types of meat, such as mouthfeel, flavor, appearance, or chemical characteristics. Meat substitutes is preferably a plant- and/or fungus-based mass and sis frequently made with soy (e.g. tofu, tempeh, and textured vegetable protein), but may also be made from wheat gluten and/or pea protein.

Alternatively or additionally, the inventive snack product may comprise a cheese component. The inventive snack product may be made at least essentially, preferably entirely from cheese. The cheese component may be intermixed with the first-and/or second mass. Additionally or alternatively, the cheese component may be a different phase in the inventive snack product, for example a filling, which is preferably at least partially surrounded by the first-and/or the second mass and/or the cheese component may be a topping which is provided that the surface of the first-and/or second mass.

Alternatively or additionally, the inventive snack product may comprise a filling, that is surrounded or at least partially surrounded by the first-and/or second mass or a topping that is provided on the surface, preferably a segment of the surface of the first-and/or second mass and/or the cheese or cheese component. The filling/topping may be a sauce, brine of any kind and/or a marmalade and/or a cheese and/or vegetables and/or potatoes and/or pasta. Preferably the filling/topping has a different consistency than the first- or second mass, particularly during consumption, e.g. when it has been heated for consumption.

The inventive protein snack product is not made from dough and preferably does not comprise any dough, particularly dough used to produce bakery products. Particularly, the first- and second mass are not made from a dough substance, particularly dough used to produce bakery products.

Inventively, the snack product is extruded to form the individual products. Particularly, the first-and/or second mass and/or the cheese is forced through an extruder, in which it is formed into the desired shape. Particularly, when a meat mass or a meat-substitute mass is extruded, fibers in the meat or meat-substitute are oriented, preferably in the extrusion direction and/or fibers are even established or their length increase, which is particularly true for the meat-substitute mass. The increase in length can be due to polymerization during extrusion and/or due to expansion of the mass due to the pressure gradient in the nozzle. This is can be fundamental difference to dough used for bakery products.

According to one embodiment of the inventive snack product, the first- and second mass differ in at least one property, preferably a property that is notable by the human consumer prior or during consumption.

The property may for example be the origin of the mass, e.g. whether it is beef or pork meat and/or the composition of the first- and second mass, a color, a texture of the mass, a fiber length, a fiber orientation and/or a spice composition.

Preferably, the first- and the second mass are provided adjacent to each other, more preferably two or more adjacent segments, for example like a chess-board. The individual segments touch each other and two adjacent segments are connected, yet visually, taste-wise and/or in terms of mouth-feel distinguishable.

According to a preferred embossment of the present invention, at least one of the first and second mass is twisted during extrusion. The twisting may take place within one of the first- or second mass. However, the first and second mass may also be twisted around each other.

Preferably, the extruded protein snack product is ring-polygonal-, stick-, disk-, spere- and/or plate-shaped. The extruded snack-product may be braided. The extruded product may be formed, preferably pressed into a certain shape, after the extrusion. For example, a cylindrically extruded product can be pressed into a sphere.

Preferably, the extruded protein snack comprises at least one coating layer. The coating may be protein product and/or flour. Preferably the coating takes place after the extrusion and before a further processing step like cooking, frying or the like.

The problem is also solved with an extruder to produce an extruded protein snack product according to one of the preceding claims comprising at least one hopper and a pump and a nozzle.

The disclosure regarding this subject matter also applies to the other subject matters and vice versa. Subject matters disclosed in connection with this subject matter can be combined with other subject matters and vice versa.

This subject matter of the present invention is related to an extruder, which particularly brings the first- and/or second meat mass into a strand with a desired shape. The individual strands are combined to a single product. Particularly, the first- and/or second mass and/or the cheese is forced through the extruder, in which it is formed into the desired shape, particularly the desired cross-section. Particularly, in case a meat mass or a meat-substitute mass is extruded, fibers in the meat or meat-substitute are oriented, preferably in the extrusion direction and/or fibers are even established or their length increase, which is particularly true for the meat-substitute mass. The increase in length can be due to polymerization during extrusion and/or due to expansion of the mass due to the pressure gradient in the nozzle. This is can be fundamental difference to dough used for bakery products.

Preferably, the extruder comprises at least two hoppers (5), two pumps (7) and a nozzle (8). Each container preferably holds a mass that differs from the mass in the other hopper in at least one property, for example its composition, its color and/or its flavor and/or its texture. Downstream of each hopper, a pump is preferably provided, which transports the mass towards the nozzle. Each pump can be controlled preferably individually, to provide a certain pressure and/or volume-flow. The pump can be for example a positive displacement pump or two rotating wheels, whose circumference is preferably provided with grooves in axial direction of the wheel.

A third or fourth hopper may contain the filling and/or the topping. To each of those hoppers preferably also a pump is allocated, which is preferably individually controllable. The pump preferably feeds the filling and/or the topping to a separate nozzle, which injects the filling into the mass strand and/or places the topping on top of the mass.

The nozzle of the extruder, that receives the masses is preferably a co-extrusion nozzle that coextrudes at least two masses and combines them to a single product.

According to a preferred embodiment of the present invention are the outlets of the co-extrusion nozzle:
two or more concentric rings or
two or more parallel rectangular or square outlets and/or
two or more segments of a rectangular or circular disk.

Preferably, the nozzle, particularly the coextrusion-nozzle is movable in at least one horizontal and/or vertical direction and/or rotatable. The nozzle can for example be moved in a horizonal plane to produce ring-shaped protein snack products. In case the nozzle is twisted around a for example vertical axis, a twisted product results.

The inner surface and/or the outlet of the nozzle may comprise indentations and/or protrusions, preferably in the extrusion direction of the product, to achieve a certain optical appearance of the surface of the strand. The indentations and/or protrusions preferably also leads to an improved orientation of the fibers in the mass and/or alter the length of the fibers.

Preferably, the extruder comprises an injection nozzle to inject a filling or topping into or on top of a mass. The nozzle, that provides the filling is preferably located between the two strands of mass and(or upstream from the extrusion nozzle. The nozzle that proved the topping is preferably located downstream from the extrusion nozzle and/or downstream from a cutting means which cuts the strand into individual pieces.

According to a preferred embodiment, the extruder comprises at least one row of adjacent nozzles, which produce a multitude of products simultaneously.

The extruder provides the snack products on a transportation means, for example a trays or an endless belt, that transports the products in a transportation direction to a next processing step. The products produced simultaneously are provided adjacent to each other in a direction perpendicular to the transport direction. During production of a snack product, the transportation means may move or stand still.

According a preferred embodiment of the present invention, the extruder comprises cutting means to cut a strand ejected by the nozzle(s) to length. Preferably, the cutting means cut the fibers of the meat and/or the meat-substitute-mass. The cutting means are preferably provided downstream from the nozzle.

The problem is also solved with a line comprising the inventive extruder and at least one of the following apparatuses: a wet coater, a dry coater, a frier, a cooker, a freezer and a packaging machine, each provided downstream from the extruder.

The disclosure regarding this subject matter also applies to the other subject matters and vice versa. Subject matters disclosed in connection with this subject matter can be combined with other subject matters and vice versa.

Upstream from the extruder the inventive line may comprise a grinder, a mixer, and/or a defroster.

The various apparatus of the line are preferably connected by one or more transportation means, preferably an endless belt. Preferably, the line has common control center which controls all apparatus of the line.

Preferably, the line comprises multiple coaters, for example a wet- and a dry-coater.

The problem is also solved by a method to produce an extruded protein snack product, wherein at least one mass is extruded in an extruder with a nozzle and then cut by a cutting means.

The disclosure regarding this subject matter also applies to the other subject matters and vice versa. Subject matters disclosed in connection with this subject matter can be combined with other subject matters and vice versa.

Preferably, prior to cutting the extruded mass is formed, for example, an extruded cylindrical strand is pressed into a sphere shape or formed into a ring.

According to a preferred embodiment, a first- and a second mass is co-extruded in the extruder, wherein the first- and the second mass differ in at least one property. After the masses have been co-extruded, they are joined and then form one product. The masses can be co-extruded as two or more adjacent strands. However, the masses can also be co-extruded as two or more concentric strands.

According to a preferred embodiment of the inventive method, a filling is injected into the mass, more preferably by providing an injection nozzle between two adjacent strands.

Alternatively or additionally a topping is added to the mass, preferably after it has been formed and placed on a transportation means.

Preferably, during extrusion, the nozzle is moved in at least one horizontal and/or vertical direction and/or rotated.

Preferably, the extruded product is coated, more preferably downstream from the extruder.

The inventions are now explained according to the Figures. These explanations apply to all subject matters of the present invention likewise. The explanations do not limit the scope of protection.

### BRIEF DESCRIPTION OF THE DRAWINGS

FIG. 1a-1e show various embodiments of the inventive protein snack product.

FIG. 2-4 show each an embodiment of the inventive extruder.

FIG. 5 show different embodiments of the inventive line.

### DETAILED DESCRIPTION

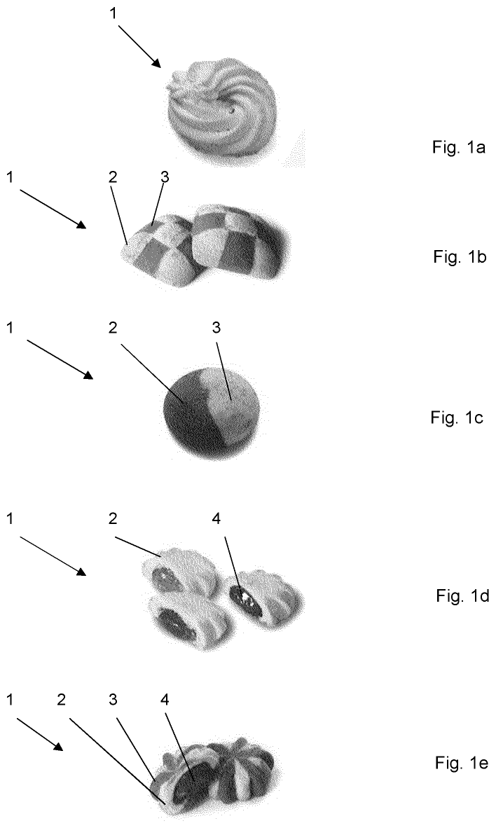

FIG. 1a shows a first embodiment of the inventive protein snack product 1, which is in the present case made from just one mass, which has been extruded and then formed into a ring, for example by moving the nozzle relative to a transportation means on which the product is placed. During extrusion the nozzle has been rotated which results in a product with a twisted appearance.

FIG. 1b shows an embodiment of a protein snack product 1 which comprises two masses 2, 3, which differ in at least one property, here the color. Each mass 2, 3 has been extruded into a multiple strands, which have then been placed adjacently and combined into a product. After the snack has been cut from the strand, it may have been further formed to get its concave surface. The circumference of this product is here square.

FIG. 1c shows yet another inventive protein product. Essentially reference can be made to the embodiment according to FIG. 1b, but in the present case the product has a round shape and the first and second mass are not segmented.

FIG. 1d shows an inventive embodiment of the inventive protein snack product here made from one mass and which comprises a filling 4. The filling can be injected into the strand before it is formed and/or injected after it has been formed.

FIG. 1e shows an inventive protein snack product comprising two masses 2, 3 and a filling 4. The filling is provided between the strands of the masses 2, 3 which are subsequently formed into the shape depicted.

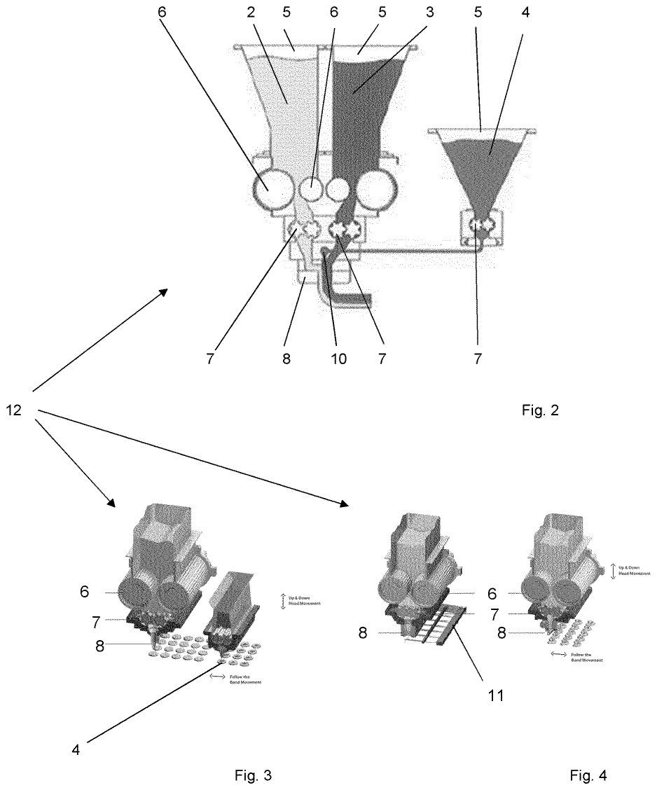

FIG. 2 shows a first embodiment of the inventive extruder 12, which comprises in the present case two hoppers 5 each comprising a mass 2, 3. The masses 2, 3 flow out of the hopper 5 and are then each pumped separately by a pump 7 towards the nozzle 8, in which they are combined to form the inventive protein snack product, for example as it is depicted in FIGS. 1b, 1c and FIG. 1e. In the nozzle fiber which may be comprised in one or both of masses 2, 3 may be oriented or formed, for example increased in their length.

In the present example, the embodiment comprises a third hopper 5 which contains here a filing 4, which is injected by a nozzle or a needle 10 between the two strands before and/or while they are combined.

The present example also shows two feed rollers which feed the mass 2, 3 towards the pump 7. These feed rollers 6 are optional and may be utilized for a mass with a high viscosity.

FIG. 3 shows an embodiment of an extruder just for one mass 2, which is formed by a nozzle into a round disklike shape. There are more nozzles 8 side by side, which simultaneously extrude products, which are placed on a transportation belt. Subsequently, a topping 4 is placed onto of each product, by a device that can be moved up and down and which can follow the motion of the products while they are topped. This device also comprises a multitude of nozzle to eject the topping 4.

FIG. 4 shows yet another embodiment of the inventive extruder, in the left hand Figure with a cutting means 11, here cutting wire. The embodiment on the right hand side shows that the extruder is preferably movable during extrusion of a product, here up and down and to follow the motion of the transportation means, which move, while the product is extruded.

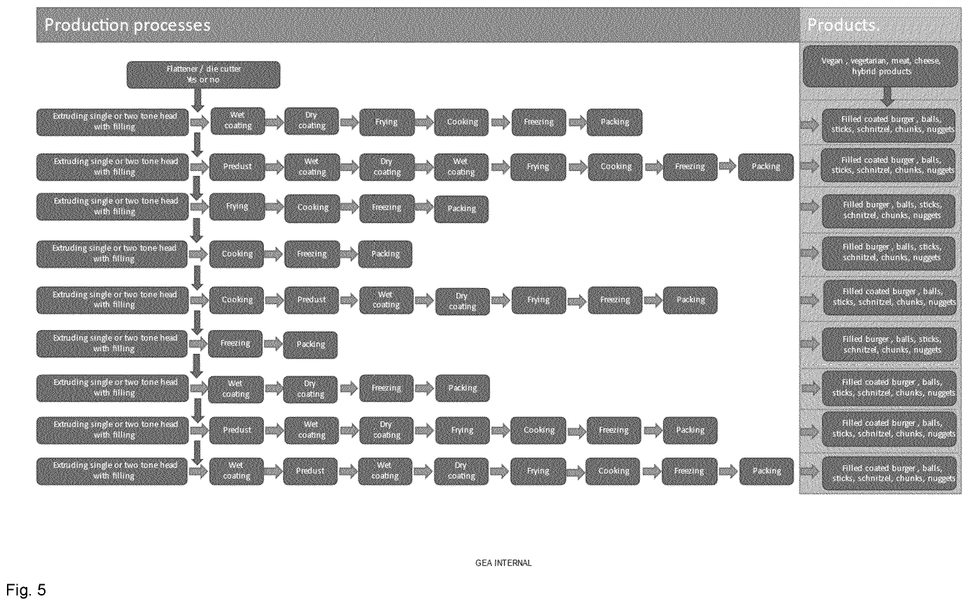

FIG. 5 shows different embodiments of the inventive line and the product which can be produced with each line.

### LIST OF REFERENCE SIGNS

1 Snack product
2 First mass
3 Second mass
4 Filling and/or topping
5 Hopper
6 Feed roller
7 Pump, preferably volumetric pump
8 Nozzle, die plate
9 Cutting means, wire cutting means
10 Injection nozzle, needle
11 Cutting means
12 extruder

1. An extruded protein snack product for human consumption comprising:
A. a first meat- and/or meat-substitute-mass: and/or
B. a second meat- and/or meat-substitute-mass, wherein the first meat- and/or meat-substitute-mass and the second meat- and/or meat-substitute-mass differ in at least one property and are at least essentially not mixed, and/or
C. a Cheese or a cheese component: and/or
D. a filling that is surrounded by at least one of A.-C.; and/or
E. A topping that is provided on the a surface of A.-C.

2. The extruded protein snack product according to claim 1, wherein the at least one property is an origin and/or composition of the first meat- and/or meat-substitute-mass and the second meat- and/or meat-substitute-mass, a color, a fiber length, a fiber orientation, and/or a spice composition.

3. The extruded protein snack product according to claim 1, wherein the first meat- and/or meat-substitute-mass and the second meat- and/or meat-substitute-mass are provided adjacent to each other.

4. The extruded protein snack product according to claim 1, wherein at least one of the first meat- and/or meat-substitute-mass and the second meat- and/or meat-substitute mass is twisted during extrusion.

5. The extruded protein snack product according to claim 1, wherein the extruded protein snack product is ring-, polygonal-, stick-, disk-, spere-, and/or plate-shaped.

6. The extruded protein snack product according to claim 1, wherein the extruded protein snack product comprises at least one coating layer.

7. The extruded protein snack product according to claim 1, wherein the meat mass comprises pork-, beef-, chicken, lamb-meat, insects, ground insects, fish, and/or cultured meat.

8. An extruder to produce the extruded protein snack product according to claim 1, comprising at least one hopper and a pump and a nozzle.

9. The extruder according to claim 8, wherein the extruder comprises at least two hoppers, two pumps. and a nozzle.

10. The extruder according to claim 8, wherein the nozzle is a co-extrusion nozzle.

11. The extruder according to claim 10, wherein the co-extrusion nozzle comprises outlets that are:
two or more concentric rings, or
two or more parallel rectangular or square outlets.

12. The extruder according to claim 8, wherein the extruder comprises an injection nozzle to inject a filling or topping into or on top of a mass.

13. The extrude according to claim 8, wherein the nozzle is movable in at least one horizontal and/or vertical direction and/or is rotatable.

14. The extrude according to claim 8, wherein the extruder comprises at least one row of nozzles, which produce a multitude of products simultaneously.

15. The extruder according to claim 8, wherein the extruder comprises cutting means to cut a strand ejected by the nozzle(s) to length.

16. A line comprising the extruder according to claim 8, wherein the line comprise at least one of the following apparatuses: a wet coater, a dry coater, a frier, a cooker, a freezer and a packaging machine, each provided downstream from the extruder.

17. The line according to claim 16, wherein the line comprises multiple coaters.

18. A method to produce an extruded protein snack product, wherein the method comprises extruding at least one mass in an extruder with a nozzle and then cutting by a cutting means.

19. The method according to claim 18, where prior to the cutting, the extruded mass is formed.

20. The method according to claim 18, wherein a first- and second mass is co-extruded in the extruder, wherein the first- and the second mass differ in at least one property.

21. The method according to claim 18, wherein the method comprises injecting a filling into the mass.

22. The method according to claim 18, wherein the method comprises adding a topping to the mass.

23. The method according to claim 18, wherein the nozzle is moved in at least one horizontal and/or vertical direction and/or rotated.

24. The method according to claim 18, wherein extruded product is coated.

25. The extruded protein snack product according to claim 1, wherein the filling comprises a sauce, brine of any kind and/or a marmalade and/or a cheese and/or vegetables and/or potatoes and/or pasta.
